(19) United States
(12) Patent Application Publication
(10) Pub. No.: US 2015/0217635 A1
(43) Pub. Date: Aug. 6, 2015

(54) AUTOMOBILE FUEL TANK

(71) Applicant: FTS CO., LTD., Toyota-Shi, Aichi (JP)

(72) Inventors: Yumi Nakane, Toyota (JP); Toshiaki Asahara, Toyota (JP); Koji Sugiura, Toyota (JP)

(73) Assignee: FTS CO., LTD., Toyota-shi, Aichi (JP)

(21) Appl. No.: 14/359,290

(22) PCT Filed: Feb. 7, 2013
(86) PCT No.: PCT/JP2013/052835

§ 371 Date: May 19, 2014

(51) Int. Cl. B60K 15/03; B60K 15/073

(52) U.S. Cl. CPC B60K 15/03177; B60K 15/03006; B60K 15/073; B60K 2015/03046; B60K 2015/03453; B60K 2015/03493

(57) ABSTRACT

A fuel tank for an automobile, which is formed by blow molding, in which a built-in part is mounted, and which has an outer wall composed of a synthetic resin, includes a plurality of mounting members adapted to mount the built-in part provided on the built-in part so as to be fusion-bonded to an inner surface of an outer wall of the fuel tank. An abutment portion is formed on each of the mounting members for abutting the inner surface of the outer wall of the fuel tank, and the abutment portion has an abutment surface and a plurality of abutment pins, each projecting from the abutment surface towards the inner surface of the outer wall of the fuel tank. A stress-absorbing part is provided in the abutment pins, the abutment surface or the outer wall of the fuel tank.

### TECHNICAL FIELD

The present invention relates to a fuel tank made of a thermoplastic synthetic resin and, more particularly, to a fuel tank of which an outer wall is formed by blow molding of the thermoplastic synthetic resin, and within which a built-in part is provided.

### BACKGROUND ART

Conventionally, metallic fuel tanks have been used as fuel tanks for automobiles, etc., but, in recent years, fuel tanks made of thermoplastic synthetic resins have been used, because they are light in weight, no rust is generated therein, and they can be readily formed into desired configurations. In many cases, the fuel tanks for use in automobiles, which are made of thermoplastic synthetic resins, have been formed by blow molding, because tubular bodies can be readily formed thereby. With a blow molding method, a parison of a molten thermoplastic synthetic resin formed into a cylindrical configuration is extruded from an upper side of a mold, and air is blown into the parison while the parison is held with the mold, thereby forming the fuel tanks for automobiles.

On the other hand, in the blow molding method, it has been also required to provide built-in parts such as valves, baffle plates adapted to suppress noise caused by the flowing of fuel, etc. in an interior of the fuel tank. To respond to this demand, there has been proposed a method of setting a built-in part in a resin frame, setting the resin frame within a mold, and bonding the resin frame to an inner surface of an outer wall of a fuel tank by blow molding, whereby the built-in part is mounted in an interior of the fuel tank (see Patent Literature 1, for example.)

In this case, however, since the built-in part is set in the resin frame, and is bonded to the inner surface of the outer wall of the fuel tank, an additional work of removing the resin frame is needed after blow molding, and in the case of small-sized built-in parts, the resin frames may become large so that the weight thereof may be increased.

In addition, in order to provide a built-in part in an interior of the fuel tank, there has been also effected such a process as is shown in FIGS. 25 and 26 (see Patent Literature 2, for example.). More specifically, as shown in FIG. 25, first, a built-in part 120 is placed on a holding rod 141 before a parison 108 enters a blow mold 140, and after the blow mold 140 is opened, the built-in part 120 is positioned therein. Then, the parison 108 is lowered with the blow mold 140 left opened, thereby positioning the built-in part 120 in an interior of the parison 108.

Then, as shown in FIG. 26, press pins 142 are made to project from both sides of the blow mold 140 before the blow mold 140 is closed, and press the parison 108 against side ends of the built-in part 120. At this time, an inner surface of the parison 14 has not been solidified so that the parison 108 and the side ends of the built-in part 120 can be fusion-bonded together. And, the holding rod 141 is lowered, the blow mold 140 is closed, and air is blown thereinto to perform blow molding.

In this case, abutment surfaces 133 formed at the side ends of the built-in part 120 for abutment with the parison 108, merely contact the inner surface of the parison 108, and the abutment surfaces 133 do not enter the parison 108, whereby adhesion therebetween is week, and the fusion-bonding strength is not sufficiently large so that the parison 108 may peel due to vibrations of fuel, expansions of fuel tanks, etc.

In addition, in order to increase the strength of the fuel tank, there has been also proposed to recess upper and lower outer walls thereof, and fusion-bond them at several positions thereof. In this case, however, since the outer wall is locally recessed and fusion-bonded together, the interior volume of the fuel tank is unfavorably reduced.

In order to overcome the above-described problem, as shown in FIG. 27, there has been also proposed a mounting member 130 for a built-in part, which has a plurality of arc-shaped projections 135 on an abutment surface 133 thereof with a triangular cross-section (see Patent Literature 3, for example.). Air release grooves 136 are provided between adjacent projections 135. However, the projections 135 are formed long into an arc-shaped configuration so that when an impact and a bending stress are applied to an outer wall of a fuel tank, not the projections 135 but the outer wall of the fuel tank may be deformed.

In order to overcome the above-described problem, as shown in FIG. 28 and FIG. 29, there has been also proposed a mounting member 230 for a built-in part, which has a plurality of column-shaped abutment pins 234 on an abutment surface 233 thereof. In this case, however, as shown in FIG. 30 and FIG. 31, the abutment pins 234 provided on the abutment surface 233 of the mounting member 230 press a parison 208 during blow molding, and a top part 235 of the abutment pin 234 enters the parison 208 from an outer surface thereof so as to be melted to weld the parison 208 and the mounting member 230 to each other. At this time, as shown in FIG. 31 (an enlarged figure of a part X in FIG. 30), a residual stress (Y in FIG. 31) is generated in molten parts of the top part 235 of the abutment pin 234, and the parison 208 due to the entry of the abutment pin 234 so that the outer wall of the fuel tank may be distorted.

### CITATION LIST

### Patent Literature

{PTL 1} Japanese unexamined Patent publication Hei1-301227

{PTL 2} Japanese unexamined Patent publication Hei6-143396

{PTL 3} Japanese unexamined Patent publication 2009-132297

### SUMMARY OF INVENTION

### Technical Problem

Accordingly, it is an object of the present invention to provide a fuel tank capable of strongly fusion bonding a built-in part to an inner surface of an outer wall thereof, and protecting the outer wall of the fuel tank by reducing a residual stress in the inner surface of the outer wall when an impact, etc. are applied to the outer wall of the fuel tank.

### Solution to Problem

According to the present invention as set forth in claim 1, in order to solve the above-described object, in a fuel tank for an automobile, which is formed by blow molding, in which a built-in part is mounted, and which has an outer wall formed from a synthetic resin, a plurality of mounting members are provided on the built-in part so as to be fusion-bonded to an inner surface of the outer wall of the fuel tank for mounting the built-in part to the fuel tank, each mounting member has an abutment portion for contacting the inner surface of the outer wall of the fuel tank, the abutment portion has an abutment surface for facing the inner surface of the outer wall of the fuel tank, and a plurality of abutment pins, each projecting from the abutment surface towards the inner surface of the outer wall of the fuel tank, each abutment pin is formed into a column-shaped or a frustum-shaped configuration, each having a circular cross-section or an elliptical cross-section, and a stress absorbing part is provided in the abutment pins, the abutment surface or the outer wall of the fuel tank.

In the present invention as set forth in claim 1, a plurality of mounting members are provided on the built-in part so as to be fusion-bonded to the inner surface of the outer wall of the fuel tank for mounting the built-in part to the fuel tank. With this arrangement, the built-in part can be fusion-bonded to the inner surface of the outer wall of the fuel tank in a plurality of positions, whereby it can be securely mounted within the fuel tank. Since the abutment portion is formed on the mounting member for abutment with the inner surface of the outer wall of the fuel tank, the abutment portion is fusion-bonded to the inner surface of the outer wall to securely fix the mounting member.

The abutment portion has an abutment surface for facing the inner surface of the outer wall of the fuel tank, and a plurality of abutment pins, each projecting from the abutment surface towards the inner surface of the outer wall of the fuel tank. Therefore, a plurality of abutment pins enter the outer wall of the fuel tank, and are fusion-bonded thereto, whereby the mounting members can be strongly bonded to the outer wall of the fuel tank.

Since the abutment pins are formed into a columnar or frustum-shaped configuration, each having a circular or elliptical cross-section, they are formed not continuously but independently of each other so that the strength of the abutment pins is smaller than that of the outer wall of the fuel tank, and consequently, where an impact, a bending stress, a flexion, etc. are applied to the outer wall of the fuel tank, damage occurs only in the abutment pins, but does not spread to the outer wall of the fuel tank and adjacent abutment pins, whereby the outer wall of the fuel tank is not affected thereby. Since the cross-sectional shape of the abutment pins is circular or elliptical, the abutment pins have no acute-angled part so that the impact, etc. applied to the outer wall of the fuel tank do not concentrate at specific areas.

A stress absorbing part is provided in the abutment pins, the abutment surface or the outer wall of the fuel tank. Therefore, where an impact, a bending stress, a flexion, etc. are applied to the outer wall of the fuel tank, stress is absorbed with the stress absorbing part, consequently the stress applied to the outer wall of the fuel tank is dispersed to reduce the impact against the outer wall of the fuel tank, whereby the stress absorptivity of the outer wall of the fuel tank can be further improved.

According to the present invention as set forth in claim 2, the stress absorbing part provided in the abutment pins is composed of grooves, each each being formed in the abutment surface at a root of each of the abutment pins so as to be extend therearound.

In the present invention as set forth in claim 2, the stress absorbing part provided in the abutment pins is composed of grooves, each being formed in the abutment surface at a root of each of the abutment pins so as to be extend therearound. With this arrangement, the abutment pins readily flex by virtue of the grooves so that when an impact, a bending stress, a flexion, etc. are applied to the outer wall of the fuel tank, the stress is dispersed in the grooves to decrease the impact and the stress against the outer wall of the fuel tank, and consequently, the stress absorptivity of the outer wall of the fuel tank can be further improved.

According to the present invention as set forth in claim 3, the stress absorbing part provided in the abutment pins is composed of notched parts, each being formed in a side surface of each of the abutment pins so as to extend therearound.

In the present invention as set forth in claim 3, the stress absorbing part provided in the abutment pins is composed of notched parts, each being formed in a side surface of each of the abutment pins so as to extend therearound. With this arrangement, the abutment pins readily flex or are readily broken in the notched parts so that when an impact, a bending stress, a flexion, etc. are applied to the outer wall of the fuel tank, the stress is dispersed or absorbed in or with the notched parts to decrease the stress and the impact against the outer wall of the fuel tank, and consequently, the stress absorptivity of the outer wall of the fuel tank can be further improved.

According to the present invention as set forth in claim 4, the abutment pins are formed to project from the abutment surface.

In the present invention as set forth in claim 4, the abutment pins are formed to project from the abutment surface. Therefore, the abutment pins enter the outer wall of the fuel tank by a long length during blow molding so that the fusion-bonding amount of the abutment pins increases, thereby strongly bonding the mounting members to the outer wall of the fuel tank.

According to the present invention as set forth in claim 5, the abutment pins are formed to have a height approximately equal to that of the abutment surface.

In the present invention as set forth in claim 5, the abutment pins are formed to have a height approximately equal to that of the abutment surface. Therefore, the abutment pins enter the outer wall of the fuel tank by a short length during blow molding so that a residual stress in the outer wall of the fuel tank can be decreased.

According to the present invention as set forth in claim 6, the stress absorbing part provided in the abutment surface is formed by decreasing the thickness of the abutment surface.

In the present invention as set forth in claim 6, the stress absorbing part provided in the abutment surface is formed by decreasing the thickness of the abutment surface. Therefore, the abutment surface is readily broken so that when an impact, a bending stress, a flexion, etc. are applied to the outer wall of the fuel tank, the abutment surface is broken to absorb the stress, thereby reducing the impact against the outer wall of the fuel tank, whereby the stress absorptivity of the outer wall of the fuel tank can be further improved.

According to the present invention as set forth in claim 7, the stress absorbing part provided in the abutment surface is formed such that the abutment surface flexes to absorb a stress applied thereto.

In the present invention as set forth in claim 7, the stress absorbing part provided in the abutment surface is formed such that the abutment surface has flexibility to flex for absorbing stress. With this arrangement, the abutment surface readily flexes so that when an impact, a bending stress, a flexion, etc. are applied to the outer wall of the fuel tank, the abutment surface flexes to disperse the stress, thereby reducing the impact against the outer wall of the fuel tank, whereby the stress absorptivity of the outer wall of the fuel tank can be further improved.

According to the present invention as set forth in claim 8, the stress absorbing part provided in the abutment surface is formed by providing a through hole in the abutment surface such that the abutment surface flexes by virtue of the through hole to absorb a stress applied thereto.

In the present invention as set forth in claim 8, the stress absorbing part provided in the abutment surface is formed by providing a through hole in the abutment surface such that the abutment surface flexes by virtue of the through hole towards the through hole to absorb a stress applied thereto. With this arrangement, the abutment surface readily flexes towards the through hole so that when an impact, a bending stress, a flexion, etc. are applied to the outer wall of the fuel tank, the abutment surface flexes to disperse the stress, thereby reducing the impact against the outer wall of the fuel tank, whereby the stress absorptivity of the outer wall of the fuel tank can be further improved.

According to the present invention as set forth in claim 9, the stress absorbing part provided in the outer wall of the fuel tank is formed by providing a recessed part in the outer wall such that the outer wall projects an interior of the fuel tank in an area for contacting the abutment portion.

In the present invention as set forth in claim 9, the stress absorbing part provided in the outer wall of the fuel tank is formed by providing a recessed part in the outer wall such that the outer wall projects an interior of the fuel tank in an area for contacting the abutment portion. With this arrangement, when an impact, a bending stress, a flexion, etc. are applied to the outer wall of the fuel tank, the stress is not applied to the area for contacting the abutment portion directly by virtue of the recessed part, thereby reducing the impact against the area of the outer wall of the fuel tank, which contacts the abutment portion, whereby the stress absorptivity of the outer wall of the fuel tank can be further improved.

According to the present invention as set forth in claim 10, the stress absorbing part provided in the outer wall of the fuel tank is formed by providing a plurality of outwardly projecting pins in an external surface of the outer wall of the fuel tank in an area for contacting the abutment portion.

In the present invention as set forth in claim 10, the stress absorbing part provided in the outer wall of the fuel tank is formed by providing a plurality of outwardly projecting pins in an external surface of the outer wall of the fuel tank in an area for contacting the abutment portion. With this arrangement, when an impact, a bending stress, a flexion, etc. are applied to the outer wall of the fuel tank, the stress is absorbed with the outwardly projecting pins, thereby reducing the impact against the area of the outer wall of the fuel tank, which contacts the abutment portion, whereby the stress absorptivity of the outer wall of the fuel tank can be further improved.

According to the present invention as set forth in claim 11, the mounting member is formed separately from or integrally with the built-in part, and is then engaged therewith.

In the present invention as set forth in claim 11, the mounting member is formed separately from or integrally with the built-in part, and is then engaged therewith. With this arrangement, where the mounting member is formed separately from the built-in part, the mounting member can be readily formed, whereby the configuration of the abutment surface of the mounting member can be formed freely. In addition, the material of the mounting member can be readily selected, and a fuel oil-resistant material that is readily fusion-bonded to the outer wall of the fuel tank can be selected. Where the mounting member is formed integrally with the built-in part, the mounting member and the built-in part can be formed by one molding so as to be formed at low costs.

According to the present invention as set forth in claim 12, the outer wall of the fuel tank includes five layers consisting of an outer body layer, an outer adhesive layer, a barrier layer, an inner adhesive layer, and an inner body layer, in this order from an exterior side of the outer layer, the outer body layer and the inner body layer are composed of a high-density polyethylene (HDPE), the barrier layer is composed of an ethylene-vinyl alcohol copolymer (EVOH), and the outer adhesive layer and the inner adhesive layer are composed of a synthetic resin having adhesiveness against both the high-density polyethylene (HDPE) and the barrier layer.

In the present invention as set forth in claim 12, the outer body layer and the inner body layer are composed of a high-density polyethylene (HDPE) so that the exterior side of the fuel tank has sufficient rigidity and sufficient impact resistance, while ensuring rigidity of the fuel tank and improving impact resistance thereof if fuel penetrates the inner body layer.

The barrier layer is composed of an ethylene-vinyl alcohol copolymer (EVOH) so that it is excellent in gasoline impermeability, and it can be formed by melt-molding with excellent workability. In addition, it has excellent impermeability under high humidity, or against gasoline containing alcohol.

The outer adhesive layer and the inner adhesive layer are composed of a synthetic resin having adhesiveness against both the high-density polyethylene (HDPE) and the barrier layer so that the outer adhesive layer and the inner adhesive layer respectively bond the barrier layer to the outer body layer and the inner body layer strongly, thereby strongly bond layers of the fuel tank into an integral body, whereby the fuel impermeability and the strength of the fuel tank can be ensured.

### Advantageous Effects of Invention

The mounting members for mounting the built-in part to the fuel tank has an abutment portion, and the abutment portion has an abutment surface and a plurality of abutment pins so that the abutment surface closely contacts the inner surface of the outer wall of the fuel tank to adjust maximum dimensions of the abutment pins entering the outer wall of the fuel tank, and the abutment pins enter the outer wall of the fuel tank to be strongly fusion-bonded to the outer wall of the fuel tank. The abutment pins are formed into a column or frustum-shaped configuration, each having a circular or elliptical cross-section, so that if an impact, a bending stress, a flexion, etc. are applied to the outer wall of the fuel tank, the abutment pins respectively absorb the impact without spreading the same, whereby the outer wall of the fuel tank is not affected thereby.

Since the stress absorbing part is provided in the abutment pins, the abutment surface or the outer wall of the fuel tank, if an impact, a bending stress, a flexion, etc. are applied to the outer wall of the fuel tank, stress is absorbed with the stress absorbing part, consequently the stress applied to the outer wall of the fuel tank is dispersed to reduce the impact against the outer wall of the fuel tank, whereby the stress absorptivity of the outer wall of the fuel tank can be further improved.

### BRIEF DESCRIPTION OF DRAWINGS

FIG. 1 is a perspective view of a fuel tank in an embodiment of the present invention;

FIG. 2 is a partial enlarged sectional view showing the construction of an outer wall of a fuel tank in accordance with the present invention;

FIG. 3 is a perspective view of a built-in part adapted to be mounted in an interior of the fuel tank in accordance with the present invention;

FIG. 4 is a plan view of a mounting member in a first embodiment of the present invention;

FIG. 5 is a sectional view of the mounting member in the first embodiment of the present invention, which is taken along the line A-A in FIG. 4;

FIG. 6 is a bottom view of the mounting member in the first embodiment of the present invention;

FIG. 7 is a sectional view of an abutment surface of the mounting member in the first embodiment of the present invention;

FIG. 8 is an enlarged sectional view of an abutment pin provided in the abutment surface of the mounting member in the first embodiment of the present invention;

FIG. 9 is an enlarged sectional view of an abutment pin provided in the abutment surface of the mounting member in the first embodiment of the present invention, which is welded to an inner surface of an outer wall of a fuel tank;

FIG. 10 is a sectional view of an abutment surface of a mounting member in a second embodiment of the present invention;

FIG. 11 is an enlarged sectional view of abutment pins provided in the abutment surface of the mounting member in the second embodiment of the present invention, which are welded to an inner surface of an outer wall of a fuel tank;

FIG. 12 is a sectional view of an abutment surface of a mounting member in a third embodiment of the present invention;

FIG. 13 is an enlarged sectional view of the abutment surface in which an abutment pin of the mounting member in the third embodiment of the present invention is formed;

FIG. 14 is a sectional view of an abutment surface of a mounting member in a fourth embodiment of the present invention;

FIG. 15 is an enlarged sectional view of an abutment pin provided in the abutment surface of the mounting member in the fourth embodiment of the present invention;

FIG. 16 is a sectional view of an abutment surface of a mounting member in a fifth embodiment of the present invention;

FIG. 17 is a sectional view showing a state in which a pressing force is applied to an outer wall of a fuel tank, to which the mounting member in the fifth embodiment of the present invention is welded;

FIG. 18 is a sectional view of an abutment surface of a mounting member in a sixth embodiment of the present invention;

FIG. 19 is a sectional view showing a state in which a pressing force is applied to an outer wall of a fuel tank, to which the mounting member in the sixth embodiment of the present invention is welded;

FIG. 20 is a sectional view showing a state in which a pressing force is applied to an outer wall of a fuel tank, to which a mounting member in a seventh embodiment of the present invention is welded;

FIG. 21 is a sectional view showing a state in which a pressing force is applied to an outer wall of a fuel tank, to which a mounting member in an eighth embodiment of the present invention is welded;

FIG. 22 is a sectional view showing a method for producing a fuel tank in accordance with the present invention, in which a blow mold is opened;

FIG. 23 is a sectional view showing the method for producing a fuel tank in accordance with the present invention, in which pressing pins of the blow mold are slid;

FIG. 24 is a sectional view showing the method for producing a fuel tank in accordance with the present invention, in which the blow mold is closed;

FIG. 25 is a sectional view showing a conventional method for producing a fuel tank, in which a blow mold is closed;

FIG. 26 is a sectional view showing a conventional method for producing a fuel tank, in which pressing pins of the blow mold are slid;

FIG. 27 is a plan view of a conventional mounting member;

FIG. 28 is a sectional view of another conventional mounting member, which is taken along the line B-B in FIG. 29;

FIG. 29 is a plan view of another conventional mounting member;

FIG. 30 is an enlarged sectional view of an abutment surface of another conventional mounting member, which is welded to an inner surface of an outer wall of a fuel tank; and

FIG. 31 is an enlarged sectional view of a portion (portion X in FIG. 30) in which an abutment pin provided in the abutment surface of another conventional mounting member is welded to the inner surface of the outer wall of the fuel tank.

### DESCRIPTION OF EMBODIMENTS

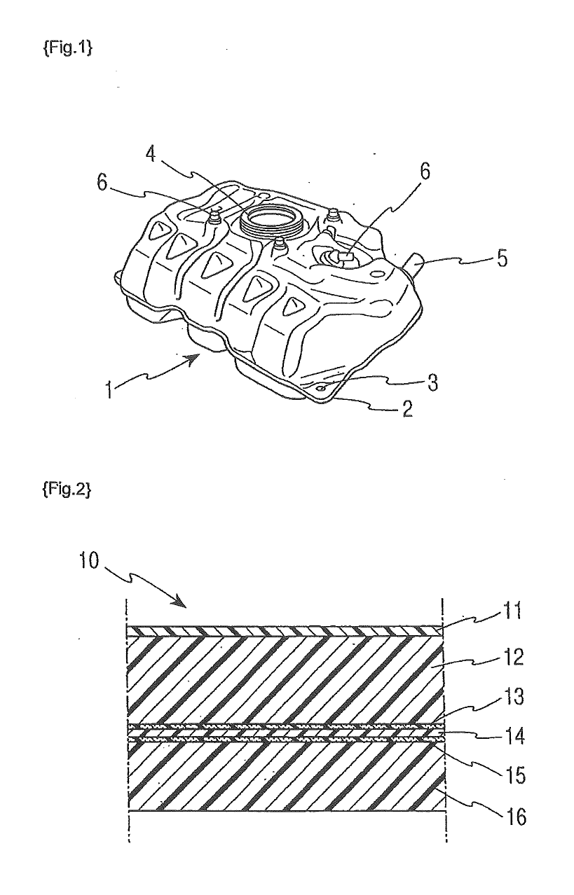

Embodiments of an automobile fuel tank 1 in accordance with the present invention will be explained with reference to FIG. 1 through FIG. 24. In the embodiments of the present invention, as shown in FIG. 1, the fuel tank 1 has a pump unit mounting hole 4 in an upper surface thereof for inserting and extracting a fuel pump (not shown) into and from the fuel tank 1. And, a fuel inlet hole 5 is formed in a side surface or the upper surface of the fuel tank 1 for supplying fuel from an inlet pipe (not shown).

In addition, an outer circumferential rib 2 is formed around the fuel tank 1 over an entire length thereof, and a plurality of mounting holes 3 are formed in the outer circumferential rib 2 in predetermined positions such as corners, etc. thereof. By bolting the mounting holes 3 and a vehicle body together, the fuel tank 1 is mounted on the vehicle body. Alternatively, the fuel tank 1 can be also mounted on the vehicle body by means of a belt wound around the fuel tank 1 without forming the mounting holes 3. In addition, mounting holes 6 are formed in the upper surface of the fuel tank 1 for connecting a hose adapted to collect evaporated fuel from an interior of the fuel tank, etc. thereto.

In the present embodiment, the fuel tank 1 is formed by blow molding, and, as shown in FIG. 2, an outer wall 10 thereof includes a skin layer 11, an outer body layer 12, an outer adhesive layer 13, a barrier layer 14, an inner adhesive layer 15 and an inner body layer 16 which are formed in that order from an exterior side thereof. Upon blow molding, a parison composed of the above-described six layers is used. A parison composed of more than six layers can be also used. As will be described later, the skin layer 11 is used where a recycled material or a filler, etc. is mixed into the outer body layer 12, but the skin layer 11 can be omitted. In addition, where a material exhibiting rigidity and fuel oil resistance is used, a parison composed of a single layer can be also used.

The skin layer 11 and the outer body layer 12 are formed from a thermoplastic synthetic resin exhibiting a high impact resistance and keeping rigidity against fuel oil, and are preferably formed from a high-density polyethylene (HDPE). When the outer body layer 12 contains an inorganic filler, the skin layer 11 is used for covering a surface of the outer body layer 12. With this arrangement, the inorganic filler is not exposed so that the surface can be made smooth.

Examples of the high-density polyethylene (HDPE) for use in the skin layer 11, the outer body layer 12 and a later-described inner body layer 16 includes later-described polyethylene. The high-density polyethylene (HDPE) exhibiting a melt rate of flow (MRF: 21.6 kg/10 min) ranging from 5 to 7, and a density (g/cm³) ranging from 0.944 to 0.950, for example, can be used.

The outer body layer 12 may be formed from a recycled material mainly containing a high-density polyethylene (HDPE) as a main material thereof. The recycled material mainly containing a high-density polyethylene (HDPE) is obtained by grinding fuel tanks 1 reclaimed after use, or grinding cut pieces and defectives produced during the producing process of fuel tanks 1. Since the fuel tank 1 is mainly composed of the high-density polyethylene (HDPE), the recycled material obtained by grinding the fuel tank 1 mainly contains the high-density polyethylene (HDPE). The recycled materials thus obtained may be used at 100% of the material for the outer body layer 46, or a newly prepared high-density polyethylene (HDPE) may be mixed into the recycled materials thus obtained.

The barrier layer 14 is formed from a thermoplastic synthetic resin passing a very small amount of fuel oil. Examples of the thermoplastic synthetic resin composing the barrier layer 14 include an ethylene-vinyl alcohol copolymer (EVOH), a polybutylene terephthalate, a polyethylene terephthalate, a polyphenylene sulfide (PPS), a liquid crystal polymer (LCP), and a semi-aromatic nylon (PPA), but an ethylene-vinyl alcohol copolymer (EVOH) is preferable. Since the barrier layer 14 is provided, fuel oil such as gasoline, etc. penetrated through the inner body layer 16 can be prevented from further penetrating by virtue of the barrier layer 14, whereby fuel oil can be prevented from evaporating into the air.

Where an ethylene-vinyl alcohol copolymer (EVOH) is used as the barrier layer 14, it exhibits excellent gasoline impermeability, and enables fusion molding so as to exhibit excellent workability. In addition, it also exhibits excellent gasoline impermeability even under a high humidity condition. Furthermore, it also exhibits excellent impermeability against gasoline containing alcohol.

The outer adhesive layer 13 is provided between the outer body layer 12 and the barrier layer 14 to bond these layers together, whereas the inner adhesive layer 15 is provided between the inner body layer 16 and the barrier layer 14 to bond these layers together. The outer adhesive layer 13 and the inner adhesive layer 15 are formed from the same material that is a synthetic resin exhibiting adhesion to both the high-density polyethylene (HDPE) and the barrier layer 14. Therefore, the outer adhesive layer 13 and the inner adhesive layer 15 strongly bond the barrier layer 14, the outer body layer 12 and the inner body layer 16 to each other so that these layers are brought into integrally close contact with each other, whereby the fuel impermeability and strength of the fuel tank 1 can be ensured.

Examples of the adhesive thermoplastic synthetic resin for use as the outer adhesive layer 13 and the inner adhesive layer 15 include modified polyolefin resins such as an unsaturated carboxylic acid modified polyolefin resin, and particularly an unsaturated carboxylic acid modified polyethylene resin is preferable. They can be produced by copolymerization or graft polymerization of an unsaturated carboxylic acid and a polyolefin resin.

The inner body layer 16 is formed from the high-density polyethylene (HDPE) that is the same material with that of the skin layer 11 described above. The inner body layer 16 has a thickness ranging from 15% to 67% of the entire thickness of the outer wall 10 of the fuel tank 1. The entire thickness of the outer wall 10 ranges from 3 mm to 8 mm so that the inner body layer 16 has a thickness ranging from 0.45 mm to 5.36 mm. Therefore, the inner body layer 16 has a sufficient thickness so that the outer wall 10 of the fuel tank 1 can keep rigidity and ensure a high impact resistance even if it swells with fuel oil.

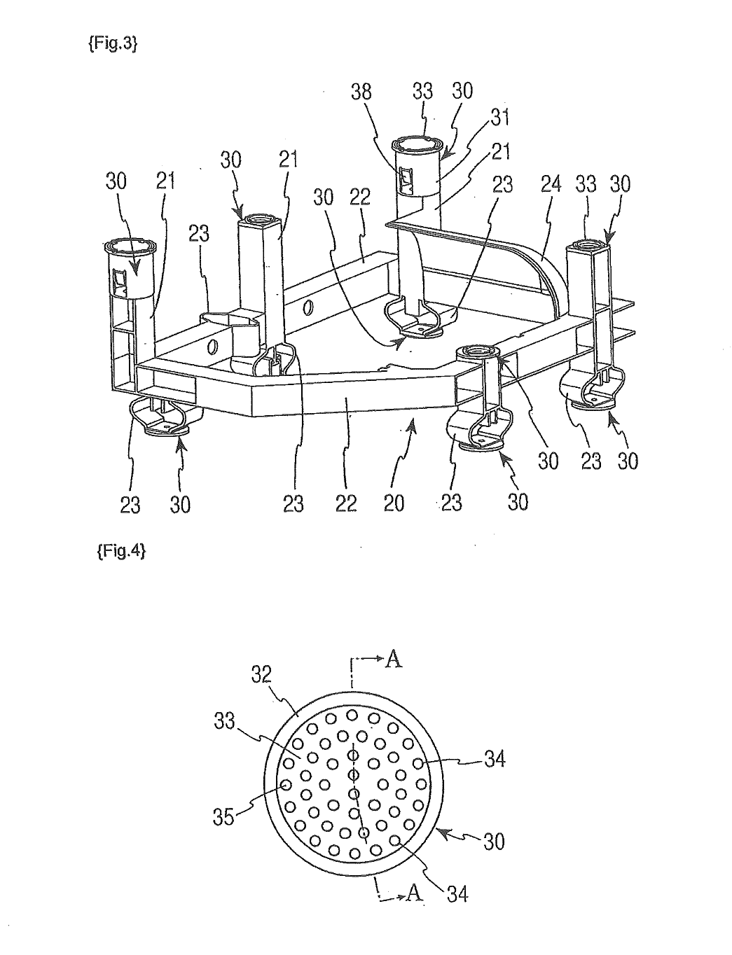

A built-in part 20 shown in FIG. 3, for example, is mounted in the interior of the fuel tank 1. The mounting method of the built-in part 20 will be explained later. Next, the built-in part 20 will be explained based on FIG. 3. The built-in part 20 has a plurality of pillar members 21 which support upper and lower parts of an inner surface of the outer wall of the fuel tank 1, and beam members 22 which connect the pillar members 21 to each other.

A mounting member 30 is secured to a distal end of the pillar member 21, which is adapted to contact the inner surface of the outer wall of the fuel tank 1. In the present embodiment, the mounting member 30 is formed separately from the pillar member 21, and secured to a distal end thereof, but, the pillar member 21 and the mounting member 30 may be formed integrally with each other. The mounting member 30 will be described later.

The pillar members 21 are mounted in predetermined positions in the interior of the fuel tank 1, and, as will be described later, by fusion bonding the mounting members 30 to the inner surface of the outer wall 10 of the fuel tank 1, the pillar members 21 are mounted in the interior of the fuel tank 1, thereby holding the outer wall 10 of the fuel tank 1 in a plurality of positions thereof. Therefore, the strength of the outer wall of the fuel tank 1 can be increased, and the expansion and contraction of the fuel tank 1 can be prevented while keeping the strength against an applied impact.

As shown in the left end portion of FIG. 3, an upper mounting member 30 and a lower mounting member 30 may be provided slightly out of alignment with each other with respect to the beam member 22. In addition, in order to overcome problems caused by contraction and expansion of the outer wall 10 of the fuel tank 1, a dimension change preventing member 23 can be formed in the pillar member 21.

The beam members 22 connect the pillar members 21 to each other, and can be mounted in predetermined positions of the inner surface of the outer wall of the fuel tank 1. In order to reduce the weight and endure the rigidity, the beam members 22 can be formed to have a U-shaped cross-section or a tubular configuration. And, as shown in FIG. 3, a baffle plate 24 can be formed integrally with the beam member 22. With this arrangement, lapping of fuel in the interior of the fuel tank 1 is prevented to suppress flowing noise of fuel therein.

In addition to the baffle plate 24, valves connected to various types of hoses, sub-tanks provided in the interior of the fuel tank 1, etc. can be provided on the beam members 22. In addition, in order to overcome problems caused by contraction and expansion of the outer wall 10 of the fuel tank 1, a dimension change preventing member 23 can be formed in the beam member 22.

The built-in part 20 can be formed from a thermoplastic synthetic resin having a fuel oil resistance, such as polyacetal, a high-density polyethylene (HDPE), etc. With this arrangement, the strength of the fuel tank 1 can be increased, and when mounted in the interior of the fuel tank 1, the rigidity of the built-in part 20 is not lowered due to swelling with fuel oil, etc.

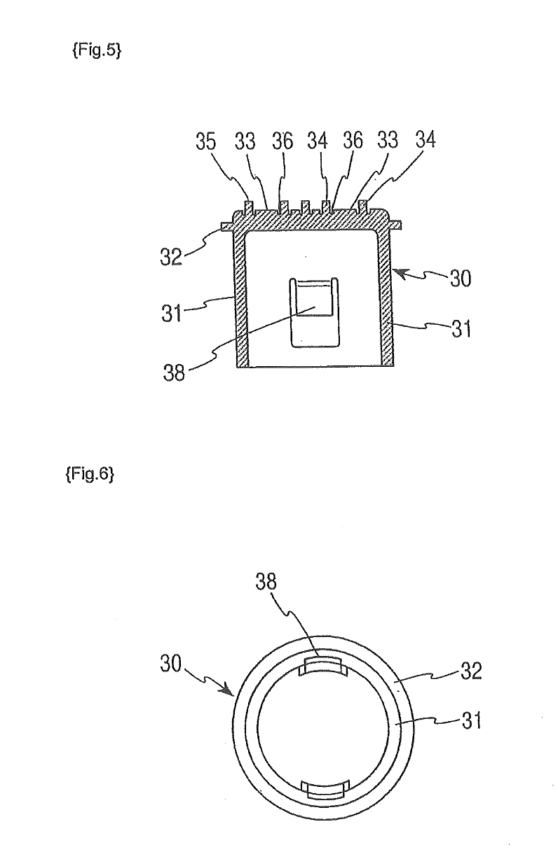

Next, the mounting member 30 will be explained. The mounting member 30 will be explained with reference to FIGS. 4 through 21 based on the first through eighth embodiments, and, first, the mounting member 30 in the first embodiment will be explained with reference to FIGS. 4 through 9. As shown in FIG. 3, the mounting member 30 may be formed into a tubular configuration with a circular or square cross-section, and a flat configuration. In the first embodiment, the mounting member 30 is formed into a cylindrical tubular configuration, and will be explained based on FIG. 4 through FIG. 6. FIG. 4 is a plan view of the mounting member 30, FIG. 5 is a bottom view thereof, and FIG. 6 is a bottom view of the mounting member.

The mounting member 30 has a connecting portion 31 connecting or continuing to the built-in part 20, and an abutment portion 32 for abutment with the inner surface of the outer wall of the fuel tank 1. In the present embodiment, the mounting member 30 is formed separately from the built-in part 20, and the connecting portion 31 is formed into a cylindrical configuration conforming to the configuration of the pillar member 21. The interior of the connecting portion 31 is hollow. Where the pillar member 21 has a square cross-section, the connecting portion 31 is formed to have a rectangular cross-section. A locking portion 38 is provided at a lower end of the connecting portion 31, and when the connecting portion 31 is fitted in the distal end of the pillar member 21, as shown in FIG. 5 and FIG. 6, a claw of the locking portion 38 is engaged with a depression or hole formed in the distal end of the pillar member 21, whereby the mounting member 30 is securely attached. In order to fusion-bond the mounting member 30 to the outer wall 10 of the fuel tank 1, the mounting member 30 is formed using the same kind of the material with that of the outer wall 10.

Where the mounting member 30 is formed integrally with the pillar member 21, the connecting portion 31 is formed continuously with the pillar member 21. Where the mounting member 30 has a flat plate-shaped configuration, no connecting portion 31 is provided therein, but it is directly attached to the distal end of the pillar member 21 through locking or bonding with a projection or a bonding surface provided on a lower surface of the abutment portion 32.

The abutment portion 32 has an abutment surface 33 with a circular configuration, which is adapted to face the inner surface of the outer wall 10 of the fuel tank 1, and a plurality of abutment pins 34 projecting from the abutment surface 33 toward the outer wall 10 of the fuel tank 1. The abutment pin 34 is formed into a column or frustum-shaped configuration with a circular or elliptical cross-section. In the present embodiment, the abutment pin 34 is formed into a column-shaped configuration with a circular cross-section. The abutment pin 34 can be also formed into a frustum-shaped configuration, or a column-shaped or frustum-shaped configuration, each having an elliptical cross-section.

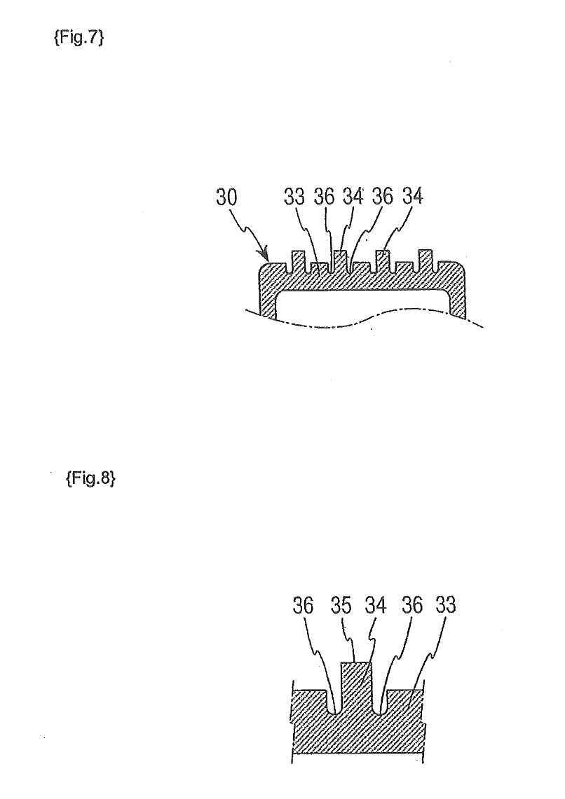

As shown in FIG. 7, grooves 36 are formed in the abutment surface 33 at a root of the abutment pin 34 such that each groove 36 surrounds a circumference of each abutment pin 34. With this arrangement, the abutment pins 34 readily flex rightwards and leftwards by virtue of the grooves 36 so that when an impact, a bending stress, a flexion, etc. are applied to the outer wall 10 of the fuel tank 1, the stress is dispersed in the grooves 36 to decrease the impact against welded parts of the abutment pins 34 and the outer wall 10 of the fuel tank 1, and consequently, the stress absorptivity of the outer wall 10 of the fuel tank 1 can be further improved.

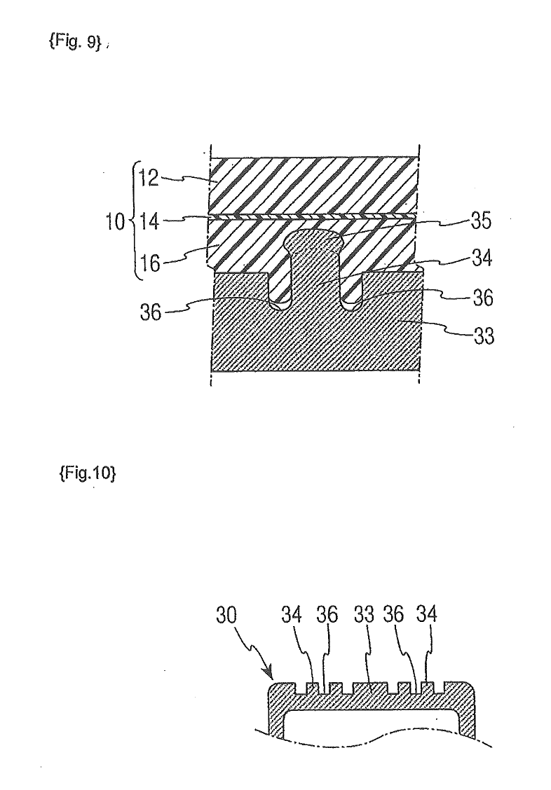

The height of each abutment pin 34 is about 0.5 to 2 mm from the abutment surface 33, the depth of each groove 36 is about 1 mm from the abutment surface 33, and the width of each groove 36 is about 0.3 mm. Where the fuel tank 1 is formed by blow molding, and the mounting member 30 is welded to the inner surface of the outer wall 10, as shown in FIG. 9, a tip end 35 of each abutment pin 34 is melted due to heat of the outer wall 10, and is welded to the inner surface of the outer wall 10. At this time, the tip end 35 of each abutment pin 34 enters the inner surface of the outer wall 10 so that stress distortion slightly remains in the vicinity of a border between each tip end 35 and the inner surface of the outer wall 10, but, as described above, each abutment pin 34 readily flexes by virtue of each groove 36 so that when an impact, a bending stress, a flexion, etc. are applied to the outer wall 10 of the fuel tank 1, each abutment pin 34 flexes, or each groove 36 surrounding each abutment pin 34 is cracked and damaged, Whereby the outer wall 10 is not affected thereby.

The abutment pins 34 are not formed continuously, but formed independently of each other so as to exhibit a lower strength than that of the outer wall 10 of the fuel tank 1. Therefore, when an impact, a bending stress, a flexion, etc. are applied to the outer wall 10 of the fuel tank 1, the abutment pins 34 are damaged, but the outer wall 10 is not affected thereby. In addition, the damage of the abutment pins 34 does not spread to adjacent abutment pins 34. Since the abutment pins 34 are respectively formed into a circular or elliptical cross-section, they do not have any acute angled part so that if an impact is applied to the outer wall 10 of the fuel tank 1, a resultant stress is prevented from being concentrated on specific areas so that when the abutment pins 34 are fusion-bonded to the outer wall 10 upon fusion-bonding the mounting member 30, the strength of the outer wall 10 of the fuel tank 1 can be maintained.

In addition, the height of the abutment pins 34 from the abutment surface 33 is formed less than the thickness of the outer wall 10 of the fuel tank 1. Therefore, a maximum entering value of dimensions when the abutment surface 33 closely contacts the inner surface of the outer wall 10 of the fuel tank 1 and the abutment pins 34 enter the outer wall 10 of the fuel tank 1 can be adjusted, and the abutment pins 34 enter the outer wall 10 of the fuel tank 1 and is strongly fusion-bonded to the outer wall 10 of the fuel tank 1.

Therefore, when the abutment surface 33 is pressed against the outer wall 10 of the fuel tank 1, the abutment pins 34 can sufficiently enter the outer wall 10 of the fuel tank 1, and contact molten parts of the outer wall 10 of the fuel tank 1 so that the tip ends 35 of the abutment pins 34 can be fusion-bonded thereto. Therefore, the outer wall 10 of the fuel tank 1 and the abutment portions 32 can be strongly fusion-bonded to each other. In addition, where the height of the abutment pin 34 ranges from 30% to 70% of the thickness of the outer wall 10 of the fuel tank 1, the abutment pins 34 do not excessively bite into the outer wall 10 so that the strength of the outer wall 10 is not lowered.

In the present embodiment, intervals between adjacent abutment pins 34 are determined to range from 1 to 3 mm. With this arrangement, when the mounting member 30 is fusion-bonded to the outer wall 10 of the fuel tank 1, a molten inner surface of the outer wall 10 can enter between adjacent abutment pins 34, whereby the abutment pins 34 can sufficiently penetrate into the outer wall 10 of the fuel tank 1. In addition, the intervals between adjacent abutment pins 34 are not excessively great so that the number of the abutment pins 34 can be increased, thereby ensuring the fusion-bonding strength against the outer wall 10 of the fuel tank 1.

In this case, when the abutment portion 32 is pressed against the inner surface of the outer wall 10 of the fuel tank 1, the abutment pins 34 enter the outer wall 10 of the fuel tank 1 as a parison 8, whereby the molten outer wall 10 of the fuel tank 1 can enter between adjacent abutment pins 34 so that the outer wall 10 of the fuel tank 1 and the abutment surface 33 can be strongly fixed to each other.

In the present embodiment, as shown in FIG. 4, the abutment pins 34 are formed over the approximately entire surface of the abutment surface 33. Therefore, a large number of abutment pins 34 can be formed on the abutment surface 33, and consequently, the outer wall 10 of the fuel tank 30 can be fusion-bonded to the entire surface of the abutment surface 33, whereby the fusion-bonding strength against the outer wall 10 of the fuel tank 1 can be ensured.

Alternatively, the abutment pin 34 can be formed on the abutment surface 33 into a frustum-shaped configuration. In this case, the cross-sectional area of the tip end of the abutment pin 34 becomes smaller so that when the outer wall 10 of the fuel tank 1 and the abutment pins 34 are fusion-bonded to each other, and the tip ends of the abutment pins 34 penetrate into the outer wall 10 of the fuel tank 1, the molten outer wall 10 readily enters between adjacent abutment pins 34, whereby the outer wall 10 and the abutment pins 34 become readily integral with each other so as to be strongly fusion-bonded to each other. In addition, since the abutment pin 34 is formed into a frustum-shaped configuration, the molten resin located between the adjacent abutment pins 34 blocks the abutment pins 34 from deeply penetrating into the outer wall 10.

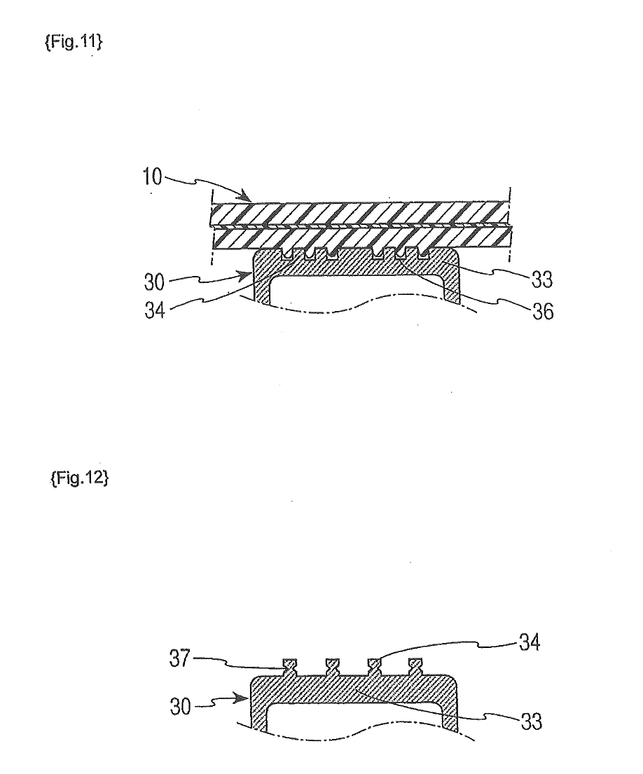

A second embodiment in accordance with the present invention will be explained with reference to FIG. 10 and FIG. 11. In the second embodiment, only the height of the abutment pins 34 differs from that in the first embodiment. Accordingly, only different points will be explained while omitting the explanation of similar points. In the second embodiment, the height of the abutment pins 34 is equal to that of the abutment surface 33, and grooves are formed around the abutment pins 34.

When a fuel tank 1 is formed by blow molding, and a mounting member 30 is welded to an inner surface of an outer wall 10, as shown in FIG. 11, tip ends 35 of the abutment pins 34 are melted with heat of the outer wall 10 and welded to the outer wall 10. At this time, since the inner surface of the outer wall 10 contacts the tip ends 35 of the abutment pins 34 and enters the groove 36, the mounting member 30 can be welded to the inner surface of the outer wall 10.

Therefore, the length of the abutment pins 34 entering the outer wall 10 of the fuel tank 1 during blow molding is short so that a residual stress of the outer wall 10 of the fuel tank 1 can be decreased. In addition, the abutment pins 34 readily flex by virtue of the grooves 36 so that when an impact, a bending stress, a flexion, etc. are applied to the outer wall 10 of the fuel tank 1, the grooves 36 around the abutment pins 34 are cracked and damaged so that the outer wall 10 is not affected thereby.

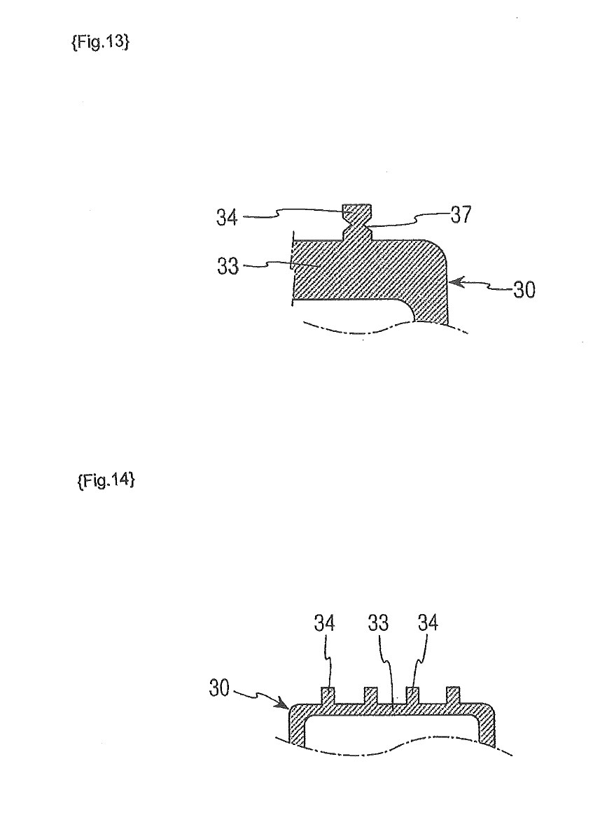

Next, a third embodiment in accordance with the present invention will be explained with reference to FIG. 12 and FIG. 13. In the third embodiment, only the grooves 36 differ from those in the first embodiment. Accordingly, only different points will be explained while omitting explanations of similar points. In the third embodiment, each abutment pin 34 has a notched part 37 as a stress absorbing part in a side surface thereof so as to surround the same. With this arrangement, each abutment pin 34 is readily flexed along the notched part 37 so that when an impact, a bending stress, a flexion, etc. are applied to the outer wall 10 of the fuel tank 1, the stress is dispersed to the notched part 37, or the abutment pin 34 is broken along the notched part 37 to reduce the impact against the outer wall 10 of the fuel tank 1, whereby the outer wall 10 of the fuel tank 1 is prevented from being affected thereby furthermore.

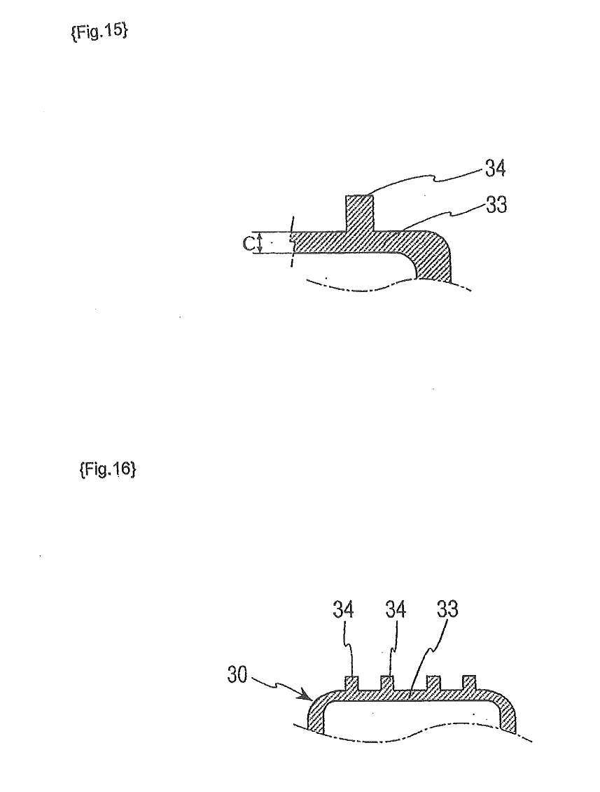

Next, a fourth embodiment in accordance with the present invention will be explained with reference to FIG. 14 and FIG. 15. In the fourth embodiment, only the abutment surface 33 differs from that in the first embodiment. Accordingly, only different points will be explained while omitting explanations of similar points. In the fourth embodiment, the thickness of the abutment surface 33 is decreased as a stress absorbing part. With this arrangement, the abutment surface 33 is readily damaged or flexed so that when an impact, a bending stress, a flexion, etc. are applied to the outer wall 10 of the fuel tank 1, the stress is dispersed to the abutment surface 33, or the abutment surface 33 is damaged to reduce the impact against the outer wall 10 of the fuel tank 1, whereby the outer wall 10 of the fuel tank 1 is prevented from being affected thereby furthermore.

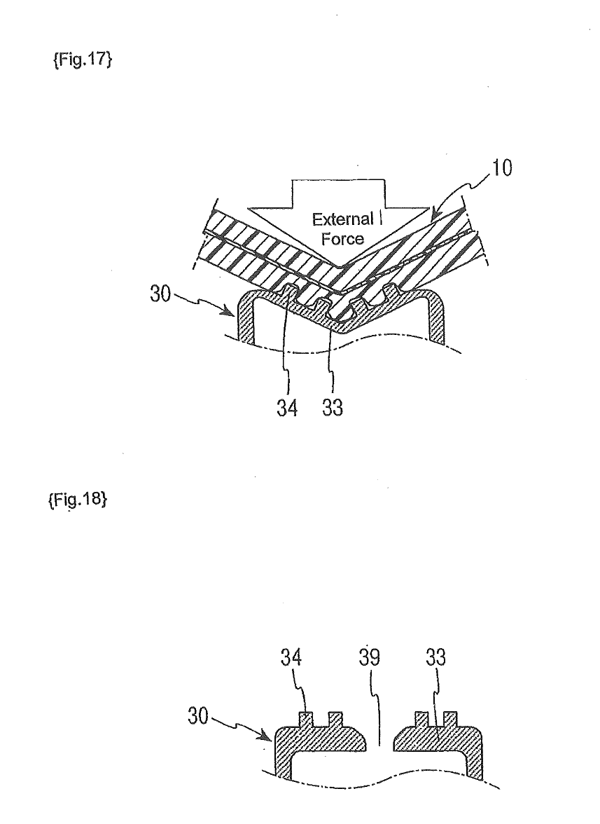

Next, a fifth embodiment in accordance with the present invention will be explained with reference to FIG. 16 and FIG. 17. In the fifth embodiment, only the abutment surface 33 differs from that in the first embodiment. Accordingly, only different points will be explained while omitting explanations of similar points. In the fifth embodiment, the rigidity of the abutment surface 33 is decreased as a stress absorbing part. With this arrangement, the abutment surface 33 is readily flexed so that when an impact, a bending stress, a flexion, etc. are applied to the outer wall 10 of the fuel tank 1 (In FIG. 17, an external force as an impact is applied to the outer wall 10 of the fuel tank 1.), the abutment surface 33 is flexed to reduce the impact against the outer wall 10 of the fuel tank 1, whereby the outer wall 10 of the fuel tank 1 is prevented from being affected thereby furthermore.

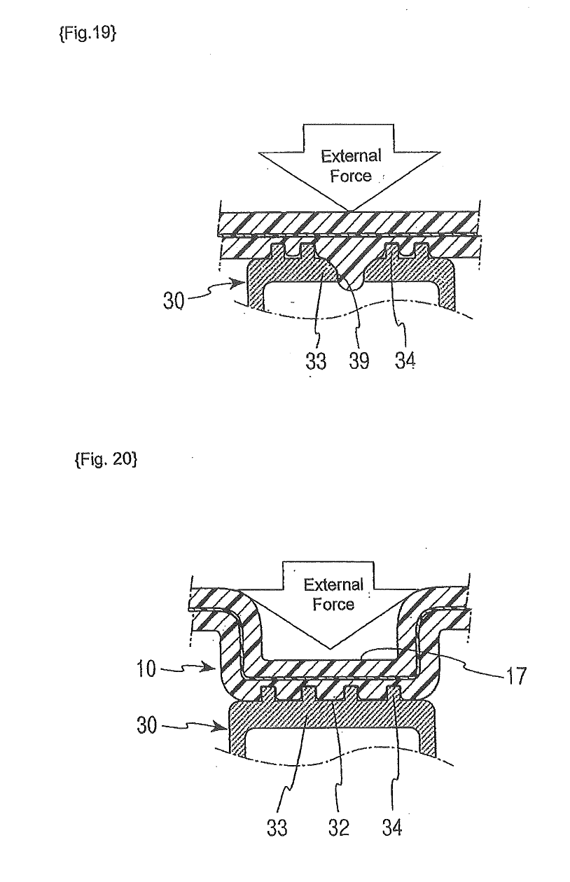

Next, a sixth embodiment in accordance with the present invention will be explained with reference to FIG. 18 and FIG. 19. In the sixth embodiment, only the abutment surface 33 differs from that in the first embodiment. Accordingly, only different points will be explained while omitting explanations of similar points. In the sixth embodiment, a through hole 39 is provided in the vicinity of a center of the abutment surface 33 as a stress absorbing part. With this arrangement, the abutment surface 33 is readily flexed in the direction of the through hole 39 so that when an impact, a bending stress, a flexion, etc. are applied to the outer wall 10 of the fuel tank 1 (In FIG. 19, an external force as an impact is applied to the outer wall 10 of the fuel tank 1.), the abutment surface 33 is flexed to reduce the impact against the outer wall 10 of the fuel tank 1, whereby the outer wall 10 of the fuel tank 1 is prevented from being affected thereby furthermore.

Next, a seventh embodiment in accordance with the present invention will be explained with reference to FIG. 20. In the seventh embodiment, only the outer wall 10 of the fuel tank 1 differs from that in the first embodiment. Accordingly, only different points will be explained while omitting explanations of similar points. In the seventh embodiment, a recessed part 17 is formed in the outer wall 10 of the fuel tank 1 as a stress absorbing part in an area to which a mounting member 30 is adapted to be welded. With this arrangement, when an impact, a bending stress, a flexion, etc. are applied to the outer wall 10 of the fuel tank 1 (In FIG. 20, an external force as an impact is applied to the recessed part 17 of the outer wall 10 of the fuel tank 1.), as shown in FIG. 20, the weight is stopped with the recessed part 17 to prevent impact and stress from being applied to the area of the outer wall 10 of the fuel tank 1, which the abutment portion 32 directly abuts, thereby reducing the impact against the area of the outer wall 10, which the abutment portion 32 abuts, whereby the outer wall 10 of the fuel tank 1 is prevented from being affected thereby furthermore.

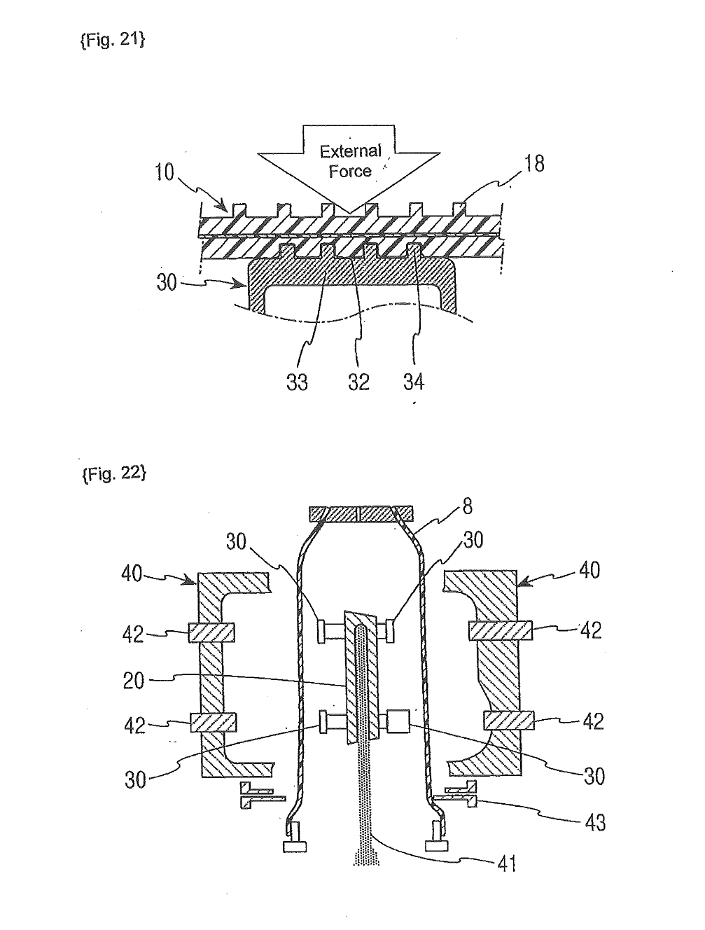

Next, a eighth embodiment in accordance with the present invention will be explained with reference to FIG. 21. In the eighth embodiment, only the outer wall 10 of the fuel tank 1 differs from that in the first embodiment. Accordingly, only different points will be explained while omitting explanations of similar points. In the eighth embodiment, a plurality of abutment pins 18, each projecting outwardly, are provided in an exterior surface of the outer wall 10 of the fuel tank 1 in the area to which the mounting member 30 is adapted to be welded. With this arrangement, when an impact, a bending stress, a flexion, etc. are applied to the outer wall 10 of the fuel tank 1 (In FIG. 21, an external force as an impact is applied to the pins 18 of the outer wall 10 of the fuel tank 1.), the stress is absorbed with the plurality of outwardly projecting pins 18, thereby reducing the impact against the area of the outer wall 10 of the fuel tank 1, which the abutment portion 32 abuts, whereby the outer wall 10 of the fuel tank 1 is prevented from being affected thereby furthermore.

Next, the producing method of the fuel tank 1 in accordance with the present invention by blow molding will be explained based on FIG. 22 through FIG. 24. First, as shown in FIG. 22, a built-in part 20 is held by a holding rod 41, and is positioned in an interior of a blow mold 40 in an open state. Then, a parison 8 is lowered to position the built-in part 20 in an interior of the parison 8.

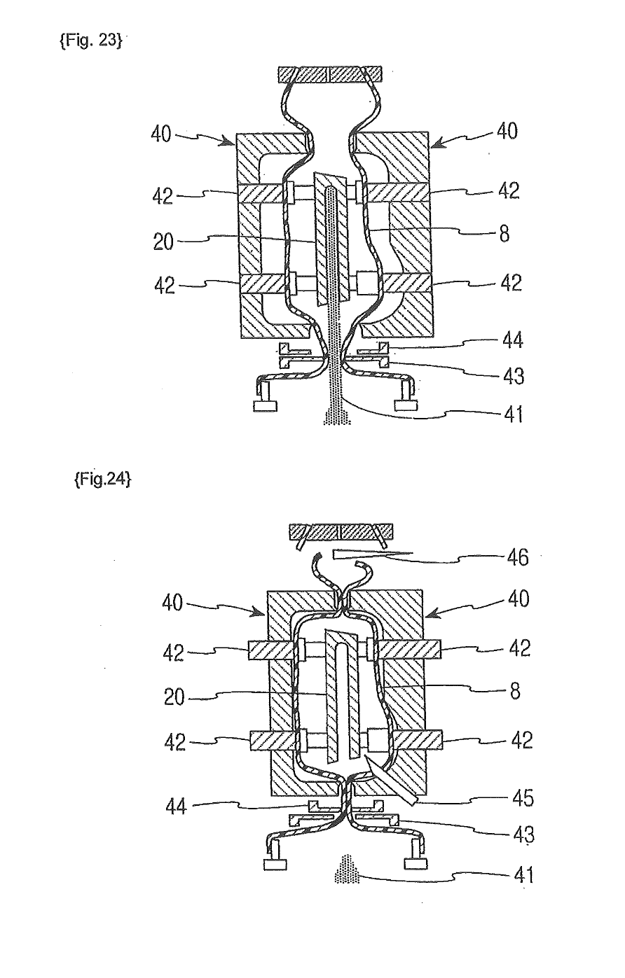

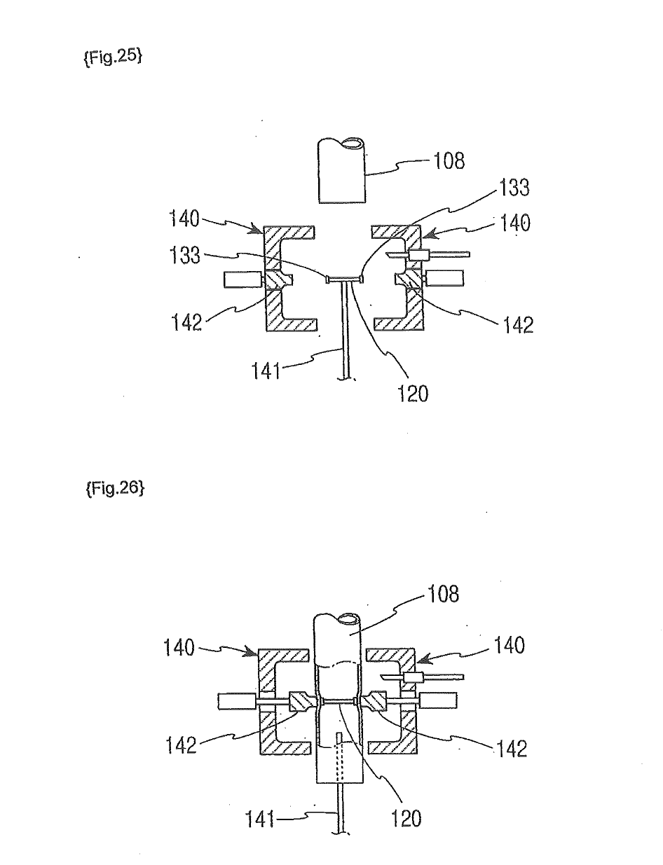

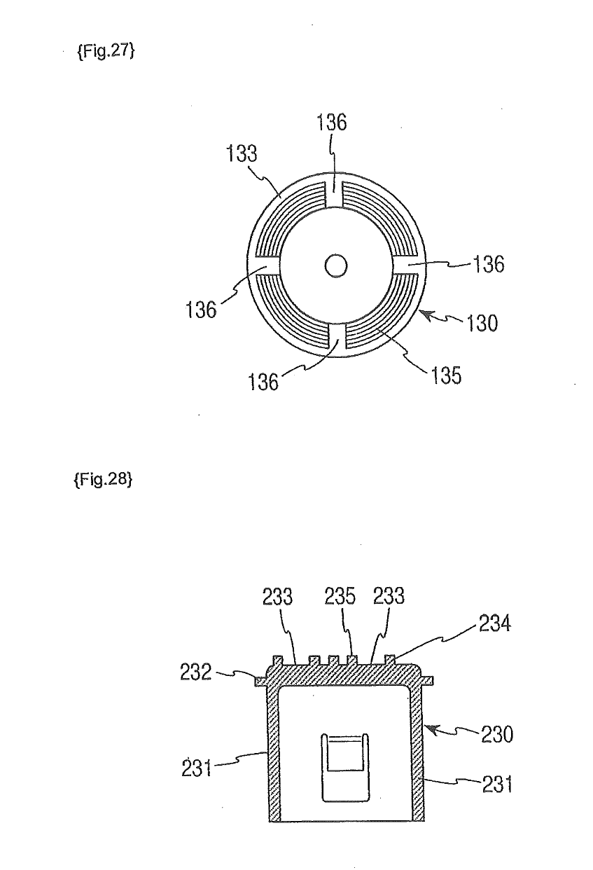

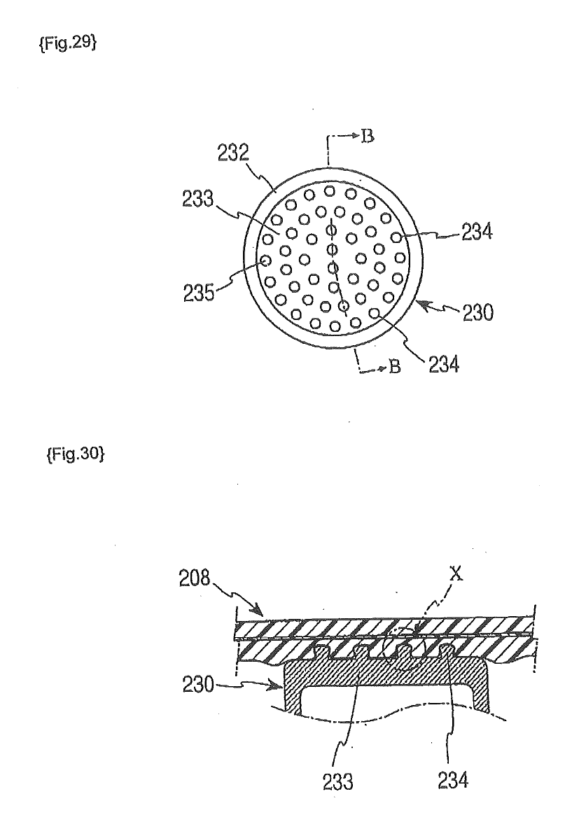

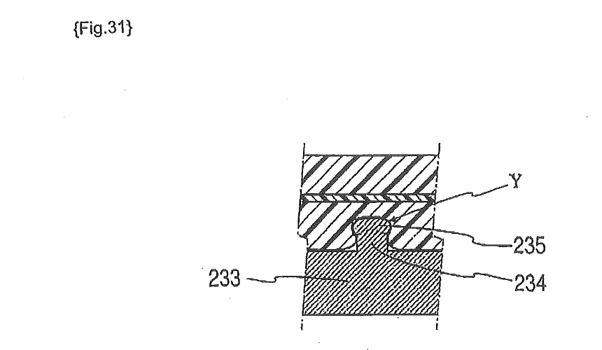

Then, as shown in FIG. 23, first pinching plates 43 are slid to hold a lower end of the parison 8 along with the holding rod 41, and a plurality of press pins 42 provided in the blow mold 40 are slid to press the parison 8 against the mounting members 30 attached to the built-in part 20 in such a manner as to hold the parison 8 therewith.

Then, the inner surface of the parison 8 is still in a molten state, and consequently, as described above, the abutment pins 34 of the abutment portions 32 of the mounting members 30 enter the inner surface of the parison 8, whereby the abutment portions 32 and the parison 8 can be fusion-bonded to each other. At this time, the built-in part 20 is held with the holding rod 41 so that the mounting members 30 and the built-in part 20 can be securely attached in prescribed positions of the outer wall 10 of the fuel tank 1.

Thereafter, as shown in FIG. 24, the holding rod 41 is lowered and removed from the blow mold 40, second pinching plates 44 are slid to close the parison 8, and the blow mold 40 is closed to cut the parison 8 with a slide cutter 46. When the blow mold 40 is closed, the press pins 42 continuously press the parison 8, thereby continuously holding the built-in part 20 in the prescribed position.

And air is blown into the interior of the parison 8 from an air nozzle 45 to press an outer surface of the parison 8 against the blow mold 40, thereby producing the fuel tank 1. At this time, projecting ends of the press pins 42 can become flush with the inner surface of the blow mold 40, defining a cavity thereof. Thereafter, the blow mold 40 is opened, and the molded fuel tank 1 is removed therefrom.

### REFERENCE SIGNS LIST

1 fuel tank 8 parison 10 outer wall 20 built-in part 30 mounting member 32 abutment portion 33 abutment surface 34 abutment pin 36 groove 37 notched part 38 through hole 40 blow mold

What is claimed is:

1. A fuel tank for an automobile, which is formed by blow molding, in which a built-in part is mounted, and which has an outer wall formed from a synthetic resin, comprises a plurality of mounting members provided on the built-in part, said mounting members are fusion-bonded to an inner surface of the outer wall of the fuel tank to mount the built-in part to the fuel tank, each of said mounting members has an abutment portion for contacting the inner surface of the outer wall of the fuel tank, said abutment portion has an abutment surface for facing the inner surface of the outer wall of the fuel tank, and a plurality of abutment pins, each projecting from said abutment surface towards the inner surface of the outer wall of the fuel tank, each abutment pin is formed into one of a column-shaped configuration and a frustum-shaped configuration, each having one of a circular cross-section and an elliptical cross-section, and a stress absorbing part is provided in one of said abutment pins, said abutment surface and the outer wall of the fuel tank.

2. The fuel tank for an automobile as claimed in claim 1, wherein said stress absorbing part provided in said abutment pins includes grooves, each being formed in said abutment surface at a root of each of said abutment pins so as to extend therearound.

3. The fuel tank for an automobile as claimed in claim 1, wherein said stress absorbing part provided in said abutment pins includes notched parts, each being formed in a side surface of each of said abutment pins so as to extend therearound.

4. The fuel tank for an automobile as claimed in claim 1, wherein said abutment pins are formed to project from said abutment surface.

5. The fuel tank for an automobile as claimed in claim 1, wherein said abutment pins are formed to have a height approximately equal to that of said abutment surface.

6. The fuel tank for an automobile as claimed in claim 1, wherein said stress absorbing part provided in said abutment surface is formed by decreasing the thickness of said abutment surface.

7. The fuel tank for an automobile as claimed in claim 1, wherein said stress absorbing part provided in said abutment surface is formed such that said abutment surface flexes to absorb a stress applied thereto.

8. The fuel tank for an automobile as claimed in claim 1, wherein said stress absorbing part provided in said abutment surface is formed by providing a through hole in said abutment surface such that said abutment surface flexes with said through hole to absorb a stress applied thereto.

9. The fuel tank for an automobile as claimed in claim 1, wherein said stress absorbing part provided in the outer wall of the fuel tank is formed by providing a recessed part in the outer wall such that the outer wall projects an interior of the fuel tank in an area for contacting said abutment portion.

10. The fuel tank for an automobile as claimed in claim 1, wherein said stress absorbing part provided in the outer wall of the fuel tank is formed by providing a plurality of outwardly projecting pins in an external surface of the outer wall in an area for contacting said abutment portion.

11. The fuel tank for an automobile as claimed in claim 1, wherein said mounting member is formed one of separately and integrally from and with the built-in part, and is engaged with the built-in part.

12. The fuel tank for an automobile as claimed in claim 1, wherein the outer wall includes five layers consisting of an outer body layer, an outer adhesive layer, a barrier layer, an inner adhesive layer, and an inner body layer, said outer body layer and said inner body layer are composed of a high-density polyethylene (HDPE), said barrier layer is composed of an ethylene-vinyl alcohol copolymer (EVOH), and said outer adhesive layer and said inner adhesive layer are composed of a synthetic resin having adhesiveness against both said high-density polyethylene (HDPE) and said barrier layer.
